(19) United States
(12) Patent Application Publication
(10) Pub. No.: US 2006/0075258 A1
(43) Pub. Date: Apr. 6, 2006

(54) Archive system and method for copy controlled storage devices

(75) Inventors: Anthony Adamson, Redhill (GB); George S Fleming, Romsey (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/534,478

(22) PCT Filed: Nov. 5, 2003
(86) PCT No.: PCT/IB03/05029

§ 371 Date: May 10, 2005

(30) Foreign Application Priority Data
Nov. 15, 2002 (GB) 0226658.3

(51) Int. Cl. G06F 12/14

(52) U.S. Cl. 713/189

(57) ABSTRACT

A data archiving system and method is described. A storage device (10) is arranged to communicate with an archival device (40) and to upload a stored file (30) thereto. The storage device (10) is arranged to generate a file encryption key and encrypt the file with the file encryption key upon upload to the archival device (40). The file encryption key can be regenerated by the storage device (10) upon presentation of the encrypted file.

The present invention relates to an archive system for copy controlled storage devices and is particularly applicable to the secure transfer of MP3 players and the like.

The digital convergence of PCs and consumer electronics (CE) devices holds enormous promise for the industry. It also poses immediate challenges. The mere prospect of hundreds of millions of dollars in copyrighted content being pirated is enough to limit issue of content in the digital domain. Indeed, some companies have developed technologies that prevent content being transferred to the digital domain. Examples include CDs designed to be unreadable in CD-ROM drives whilst still being playable in HiFis to prevent the ripping of the audio data on them. Various systems exist which create errors on the CD, which are corrected in HiFi CD players, but make the disk unreadable in CD-ROM drives.

Other than creating ill-feeling with users, one potential problem is that these systems restrict people from recording music for private, noncommercial uses and may contravene laws allowing home recordal and/or transfer of the data to another medium.

In order to address this, many systems have been suggested that provide limited copying/movement of digital content data to the legal owner.

Some existing suggestions seek to store data encrypted on a device, so that only the originator would be able to retrieve the file. However, for storage devices required to output data in real time, the encryption overhead can be problematic. Particular problems with encrypted files are encountered with so-called trick-play Dumping forwards/backwards whilst playing).

In order to address these and other issues, the Digital Transmission Licensing Authority (DTLA) have proposed a content protection system for the IEEE 1394 bus specification dealing with isochronous transmissions. The system provides content protection so that copyrighted and other valuable content can be protected from unauthorized copying. The system specification is called the Digital Transmission Control Protocol (DTCP) and is incorporated herein by reference.

Providing secure isochronous communications is important because all nodes on the network have access to the data being transmitted and so could take additional copies. In contrast to asynchronous transmissions where the identity (or at least some identifier) of the transmitter and receiver is known by both parties, implementations of isochronous transmissions typically take the form of a broadcast where identity of the sink (receiving) device may not necessarily be known by the source (data providing) device.

Content data is typically transmitted over IEEE 1394 bus as isochronous transmissions whilst control data is transmitted using asynchronous control packets. In order to provide the necessary content protection, the DTCP requires that isochronous transmissions are encrypted using a symmetric cipher system during transmission.

In a DTCP system, when accessing an isochronous transmission on the IEEE 1394 bus, a sink device (the recipient of the data) first authenticates with the source device (the holder of the data). During authentication, relevant encryption/decryption keys are obtained/agreed so that the sink device can decode the isochronous transmission upon receipt.

A particular benefit of this system is that encryption occurs at the link layer. Content is therefore available unencrypted above the link layer, making application functions such as trick play and searching much easier than if the data was encrypted.

A copy control system is also incorporated. Content owners can specify how their content can be used (“copy-once,” “copy-never,” etc.). This information is embedded within the content as copy control information (CCI) and communicated within isochronous transmissions. Onward transmission of content is limited by the IEEE 1394 bus and IEEE 1394 devices in dependence on CCI status.

The link-layer solution encrypts the link between the two devices and uses embedded copy-control-information (CCI) from the data to determine whether the data needs to be encrypted or indeed can even be transmitted. Data at each end is stored decrypted with the CCI being stored with the data. In this way, communications between devices are secure.

One problem with copy control mechanisms is that they are generally poor at, or lack, backup systems. For example, a “copy never” or “copy-no-more” data file under the IEEE 1394 system cannot be transferred from the storage device/medium holding it. In the event that the media or device is stolen, lost or fails, the data file is lost too.

The concepts of copy control limitation of content data and that of archival have to date conflicted. On one hand, a user wishes to be able to back-up content data in case the device is lost, stolen etc. On the other, the content provider wishes to limiVprevent movement and copying of content data to prevent copyright theft. Another problem with storage devices is that they can only hold a limited amount of content data—once that amount is reached, existing content data must be overwritten in order to introduce new content data to the device. Where copy control is enforced, content data that may have been purchased would have to be irretrievably overwritten to allow new content data to be stored. This is seen as a negative factor by the purchaser of such devices who would not wish to purchase content data each time they wished to copy it onto a storage device.

According to one aspect of the present invention, there is provided a data archiving system for a storage device arranged to communicate with an archival device and to upload a file thereto, wherein the storage device is arranged to generate a file encryption key and encrypt the file with the file encryption key upon upload to the archival device, the file encryption key being regeneratable by the storage device upon presentation of the encrypted file.

Data files are encrypted during archival and only the originating, “owner”, device is able to gain access to them in a decrypted state. In one embodiment, this is achieved by embedding part of the seed necessary to generate a decryption key in a header to the encrypted file. Only the owner device has remaining part allowing the file to be decrypted. To retrieve any encrypted files previously stored, the device recreates an encryption key based on a shared seed that is split between the header of the encrypted file and the device itself. This shared seed is used during the encryption process and is then stored in the storage device or at least partly in the file itself.

The storage device may include a private encryption key, the file encryption key being generated in dependence on a randomly generated number and the private encryption key, wherein the randomly generated number is stored in a header to the file upon uploading.

The storage device may include a private encryption key and a file encryption key database, the file encryption key being generated in dependence on the private encryption key, wherein data necessary to generate a decryption key to decrypt the encrypted file is written to the file encryption key database upon uploading. Data to match the encrypted file to the data necessary to generate a decryption key may be written to the encryption key database upon uploading.

The storage device may include a file encryption key database, wherein the file encryption key is written to the file encryption key database upon uploading. An identifier may be written to the file and to the file encryption key database upon uploading to associate the file encryption key with the encrypted file.

According to another aspect of the present invention, there is provided a data archiving method comprising:

generating a file encryption key;

encrypting a file with the file encryption key; and, uploading the encrypted file to an archival device;

regenerating the file encryption key upon download of the encrypted file; and,

decrypting the file with the regenerated file encryption key.

The step of generating the file encryption key may comprise generating the file encryption key in dependence on a randomly generated number and a private encryption key and storing the randomly generated number in a header to the file, wherein the step of regenerating the file encryption key comprises the step of obtaining the randomly generated number from the header to the file and regenerating the file encryption key in dependence on a randomly generated number and the private encryption key.

The method may further comprise the step of storing data necessary to regenerate the file encryption key in a file encryption key database.

The method may further comprise the step of writing data to the file encryption key database for matching the encrypted file to the stored data necessary to regenerate the file encryption key.

The method may further comprise the steps of writing an identifier to a header of the file, the identifier comprising the data for matching the encrypted file to the stored data.

An example of the present invention will now be described in detail, with reference to the accompanying drawings in which:

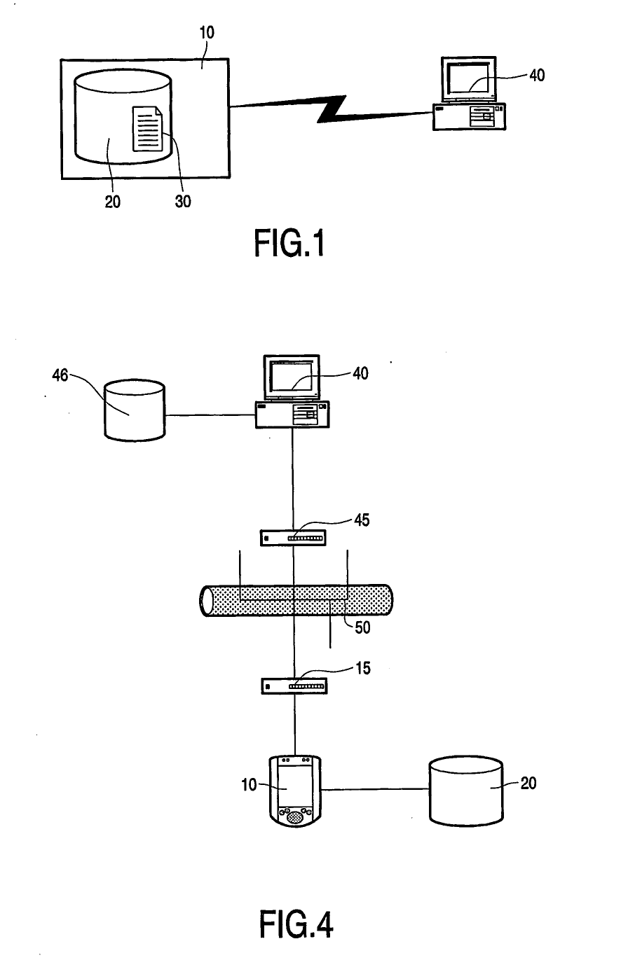

FIG. 1 is a schematic diagram of a data archiving system according to an embodiment of the present invention;

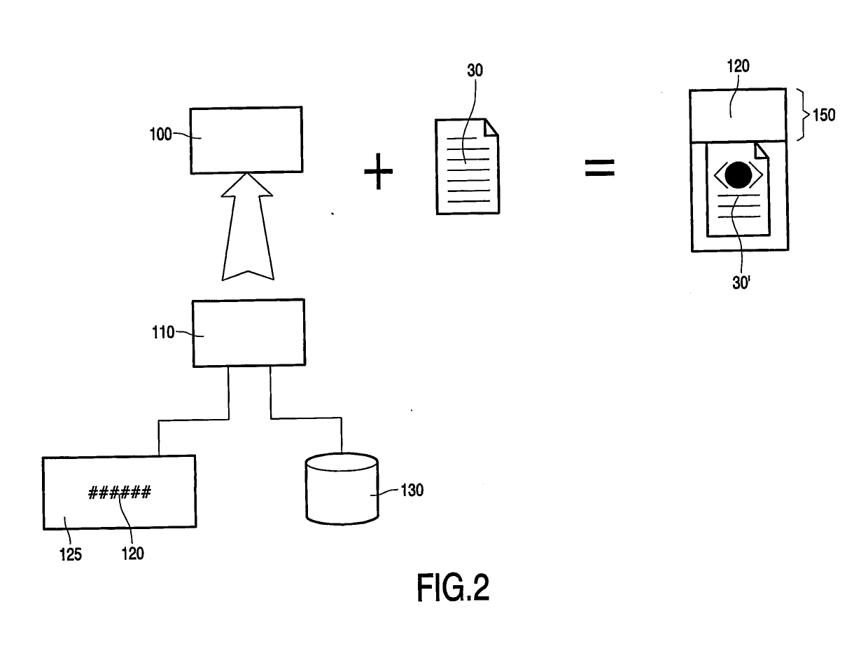

FIG. 2 illustrates an embodiment of a system for generating and regenerating the split encryption key;

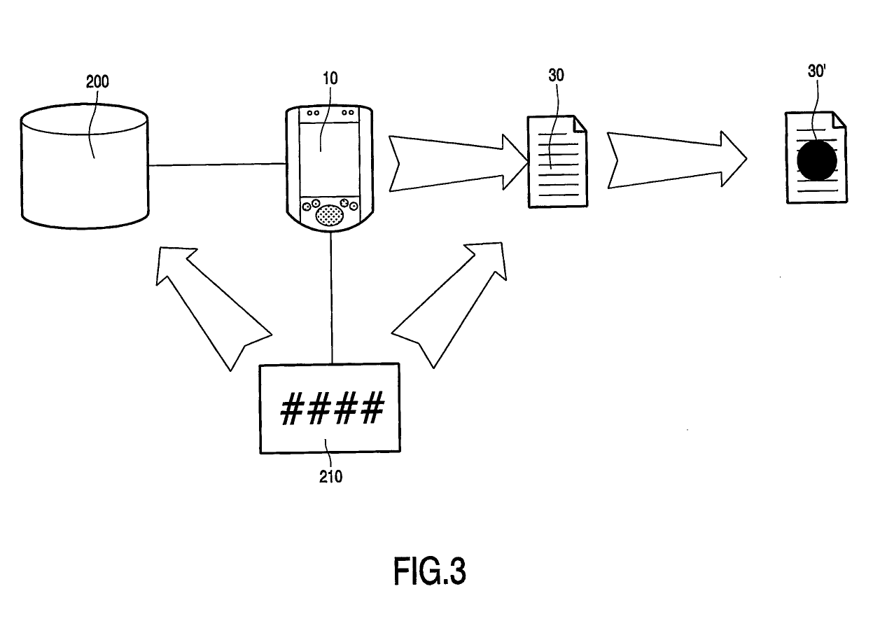

FIG. 3 illustrates another embodiment of a system for generating and regenerating the split encryption key;

FIG. 4 is a schematic diagram of an asynchronous communication system suitable for supporting the embodiment of FIG. 2 or 3;

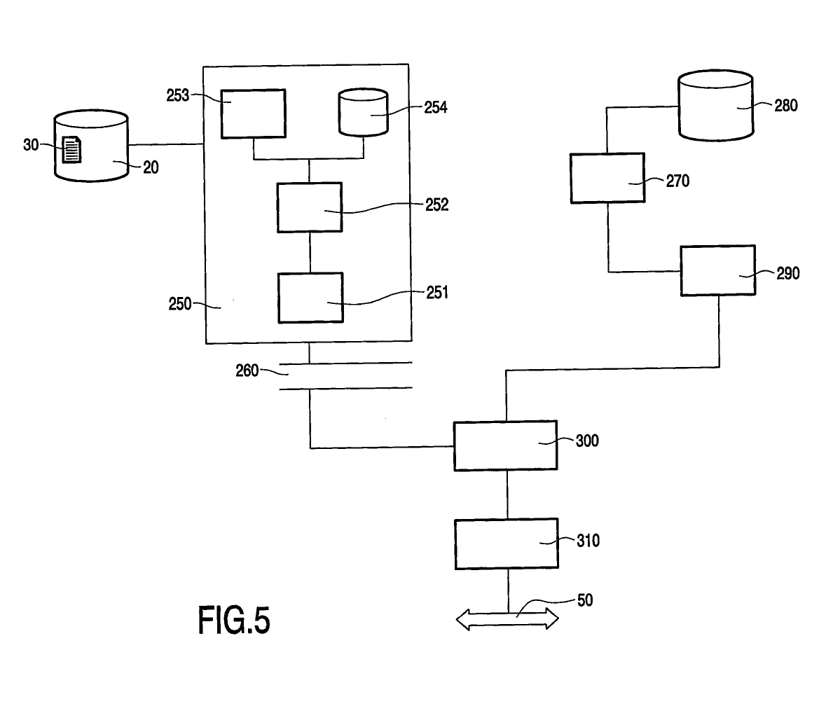

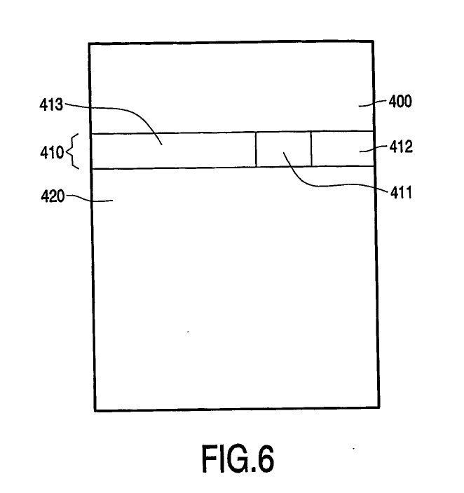

FIG. 5 is a schematic diagram of the owner device of FIG. 4; and, FIG. 6 is a schematic diagram of the format of an asynchronous packet extended for use in an embodiment of the present invention.

FIG. 1 is a schematic diagram of a data archiving system according to an embodiment of the present invention.

A storage device 10 includes a data storage medium 20 for holding content data files 30. Files are selectively transferred or copied from the storage device 10, referred to as an owner device, on demand to an archival device 40 for archival or storage.

When a file is transferred or copied, it is encrypted by the owner storage device 10. The archival device 40 stores the file in encrypted form and allows it to be freely copied. The decryption key is stored in such a manner that it is derivable only by the owner device.

One embodiment of a system for generating and regenerating the split encryption key is illustrated in FIG. 2.

Archival is initiated upon receipt by owner device 10 of an appropriate command from archival device 40. An encryption/decryption key 100 is generated by a content key generator 110 in the owner device 10 using a random number 120 generated by a random number generator 125 in conjunction with a private key 130 of the owner device 10. The content data file 30 is encrypted using the encryption/decryption key 100 and the random number 120 is then stored in a header 150 to the encrypted file 30′. The encrypted file 30′ is then transmitted to the archival device 40 for storage, recordal to another storage medium, onward transmission or any other use envisaged by the user.

The private key 130 is unique to the owner device 10. Therefore, even if a third party obtained the encrypted file 30′ and extracted the random number 120 from the header 150, the encryption/decryption key could not be regenerated and thus the unencrypted content data file 30 could not be accessed.

Should it be desired to restore the encrypted file 30′ to the owner device 10, the archival device 40 (or any other connected device) transmits the encrypted file 30′ with an appropriate command to the owner device 10. The command instructs the owner device 10 to restore the associated file. Upon receipt of the encrypted file 30′, the owner device obtains the random number 120 from the header 150 and combines this with its private key 130 in the content key generator 110 to regenerate the encryption/decryption key 100. The content data file 30 can then be decrypted and stored in the data storage medium 20 for subsequent access.

If the encrypted file 30′ was downloaded onto another storage device, the combination of that storage device's private key and the random number 120 from the header 150 would not result in the correct encryption/decryption key 100 and the unencrypted content data file 30 could not be accessed.

The commands transmitted from the archival device 40 and the owner device 10 may be made using the AV/C (Audio Visual Control) protocol.

The random number could be generated using one of the many known techniques for random number generation.

FIG. 3 illustrates another embodiment of a system for generating and regenerating the split encryption key.

As an alternative to storing the random number in a header to the file, the random number 120 is stored in a database 200 in the owner device 10.

The encryption/decryption key 100 is generated by a content key generator 210 in the device 10. Data necessary to generate the decryption key 100 is stored in the database 200 on the owner device 10 along with file information so that appropriate data can be matched to encrypted files 30′ to enable decryption. The data and file information is written to the database 200 at the time of encrypting the file 30′.

As in the previous embodiment, the encryption key used to encrypt the file 30 is specific to the data file 30 and to the owner device 10 so other players would not be able to decrypt the file. However, it is the pairing of the encrypted file 30′ and the device 10 that identifies “ownership”. Authentication and Copy control information that would normally be used to restrict transfer of copy controlled content does not need to be respected or inspected as the content data file 30 is not accessible to any device other than the owner device 10. In this manner, the archival device could permit copying/transfer to any destination including multiple downloads to any one device in the knowledge that only the legitimate owner can access the data file in an unencrypted form.

As an alternative to storing file information in the database 200, an identifier (from which the encryption/decryption key is not derivable) may be stored in a header to the encrypted file 30′. The identifier would also be stored with the random number 120 in the database 200. When presented with an encrypted file, the device 10 would obtain the identifier and find the random number 120 in the database 200 with a corresponding identifier. Another variation that may be combined with the above embodiments would be to store the whole encryption/decryption key 100 in the database 200 instead of the random number 120.

The encrypted version of the file 30′ held on the archival device 40 can then be transferred elsewhere for safe keeping (such as burnt onto a CD/DVD) and may be copied freely.

FIG. 4 is a schematic diagram of an asynchronous communication system suitable for supporting the embodiment of FIG. 2 or 3.

The owner device 10, such as an MP3 player, is DTCP compliant and includes a storage device 20 holding content data 30 such as MP3 encoded audio files, MPEG multimedia files and the like. At the option of the author/originator, the content data may include copy control information (CCI) to limit distribution of the data. The source device 10 is connected to an IEEE 1394 bus 50 via an IEEE 1394 bridge 15.

The archival device 40 includes an IEEE 1394 bridge 45 for connection to the bus 30 and a storage device 46.

Taking as an example, the archival device 40 requests the owner device 10 archives an MP3 file 30 to it. The owner device 10 includes an IEEE 1394 chip as part of the DTCP system. An encryption key is generated in a manner as discussed above and the MP3 file 30 is then packetised and encrypted using the encryption system of the IEEE 1394 chip of the device 10. The random number or other identifier is added to the encrypted packets as a payload header and is illustrated below in more detail. The encrypted packets are then transmitted asynchronously over the bus 50. No authentication is necessary between the owner device 10 and the archival device 40. Components of the DTCP system of the owner device 10 are used to achieve the encryption.

At the archival device 40, the encrypted packets 30′ are received. However, the encrypted packets 30′ are not decrypted (and could not be as the archival device does not hold the decryption key). The packets 30′ are stored in an encrypted form in the storage device 46. Preferably, the storage device 20 is configured so that it cannot be removed and attached to a PC or other device for access of data. For example, this could be achieved mechanically by limiting interfaces on the device to a single IEEE 1394 bridge. As this is the only point of data access to the storage device, authentication would have to take place to access data in an unencryptyed form and this could not be circumvented given that no IDE connection or the like is provided. Another alternative would be to use non-removable media or media such as NVRAM as the storage device 20.

DTCP is applied to the asynchronous transmissions in a similar manner to that of isochronous transmissions. In order to apply the DTCP to asynchronous transmissions, the payload header also includes copy control and key change information. The packet structure including the payload header is discussed in more detail below with reference to FIG. 4. Where they are used, all other mechanisms are consistent with the current DTCP specification, with the exception that encrypted packets are transmitted asynchronously, not isochronously. It should however be emphasized that mechanisms such as authentication need not be used when merely archiving/restoring files.

New extension commands for the Audio Video device Command and Control protocol, specified for the IEEE 1394 bus and issued by the 1394 Trade Association (www.1394ta.orc) and incorporated herein by reference, are implemented in order to allow encryption of asynchronous packets and the initiation of archival/restoration.

Copy control information embedded within the data may be used to initiate encryption when archiving. For example, the system may be set to force copy limited files to be archived whilst allowing free access to copy freely files.

FIG. 5 is a schematic diagram of the owner device 10 of FIG. 4.

The device includes the storage device 20 connected via an encryption module 250 to an asynchronous transmission buffer 260. The buffer 260 communicates with the link layer 300 of the IEEE 1394 bridge of the device.

The device also includes an AKE system 270 in communication with a certificate store 280 for storing certificate(s) for the device. The AKE system 270 is connected to an AV/C control system 290 which in turn communicates with the link layer 300 of the IEEE 1394 bridge of the device. The link layer 300 communicates with the physical layer 310 which is connected to the physical IEEE 1394 bus 50.

The encryption module 250 includes a scramble/descramble unit 251, a key generator 252, a random number generator 253 and a private key store 254. When a file 30 is to be transmitted from the storage device 20, the file is packetised ready for transmission. The key generator 252 obtains the private key from the private key store 254 to generate an encryption key. This is combined with a random number from the random number generator 253 to create a random encryption key. This is then passed to the scramble/descramble unit 51 and used to encrypt the file 30. The random number or other identifier is then stored in a payload header. The packets are then passed to the buffer 260 for asynchronous transmission.

As discussed above, data is decrypted upon receipt by obtaining the random number or other identifier from the payload header of the encrypted packets. Using the obtained information, the random encryption key is regenerated. This is then used to decrypt the packets. The decrypted, depacketised file is then passed to the storage device 20 unencrypted. In order to avoid the storage device being placed in an ordinary PC and having its data read with no security preventing this, it is preferable that the only digital output for data on the storage device 20 is via the IEEE 1394 bridge and its illustrated components herein. It is important to note in such a scenario that the storage device 20 is prevented mechanically from being removed and interrogated on a standard platform such as a PC. Any access to data in an unencrypted form on the storage device is via the bridge and consequently utilizes the IEEE 1394 and DTCP protocol stack. Where access is requested to data on the storage device, the Authentication and Key Exchange (AKE) procedure, as described in the DTCP specification, is instigated. Only authenticated, encryption enabled, devices would be able to gain access to this data in an unencrypted form, although for archival purposes, any device could instigate the archival procedure. Inserting the storage device into a normal PC for use as a standard IDE or SCSI hard disk would not be possible due to mechanical incompatibility, and connecting it to a standard IEEE 1394device (without the DTCP encryption system) would result in failure of the AKE.

It will be apparent that encryption cannot occur at the link layer in asynchronous transmission like in isochronous transmissions. DTCP performs the encryption in the link layer and is able to do this due to the provision of Encryption Mode Indicator (EMI) and Odd/Even bits in the isochronous packets. These respectively denote the CCI of the file and when key changes occur. In asynchronous packets, these bits are not available and so have to be added on in the payload header. In order to achieve this, encryption takes place above the link layer.

FIG. 6 is a schematic diagram of the format of an asynchronous packet extended for use in an embodiment of the present invention.

The packet includes a standard header 400, a payload header 410 and a payload 420. The standard header 400 is consistent with headers used in DTCP and IEEE 1394 networks. The payload header 410 includes an EMI field 411 used to convey CCI information, an odd/even field 412 used to convey key change notification and the random number or other identifier 413 used in regeneration of the encryption key. The values and usage of the EMI and Odd/Even bit are identical to the DTCP specification for isochronous packets. The payload 420 includes the encrypted packet of data.

Whilst the random number or other identifier have been discussed above as being included in the payload header of each packet, it is possible that it may only be included in the payload header of a predetermined (such as first or last) packet. In such a scenario, each packet would have some identifier to designate the data stream it belongs to and thereby allowing correct depacketisation.

In addition, in the above embodiments, a file or data stream to be archived are divided into individual packets and then encrypted. This means that a number of encrypted packets are archived at the archival device and all packets must be returned to the owner device to allow restoration. Other embodiments are possible where the whole file or data stream is encrypted as a single entity and archived, allowing simpler file handling and the like.

1. A data archiving system for a storage device (10) arranged to communicate with an archival device (40) and to upload a file (30) thereto, wherein the storage device (10) is arranged to generate a file encryption key (100) and encrypt the file (30) with the file encryption key upon upload to the archival device (40), the file encryption key (100) being regeneratable by the storage device (10) upon presentation of the encrypted file (30′).

2. A data archiving system according to claim 1, wherein the storage device includes a private encryption key, the file encryption key (100) being generated in dependence on a randomly generated number (120) and the private encryption key, wherein the randomly generated number (120) is stored in a header (410) to the file (30) upon uploading.

3. A data archiving system according to claim 1, wherein the storage device (10) includes a private encryption key and a file encryption key database, the file encryption key (100) being generated in dependence on the private encryption key, wherein data necessary to generate a decryption key to decrypt the encrypted file (30′) is written to the file encryption key database upon uploading.

4. A data archiving system according to claim 3, wherein data to match the encrypted file (30′) to the data necessary to generate a decryption key is written to the encryption key database upon uploading.

5. A data archiving system according to claim 1, wherein the storage device (10) includes a file encryption key database, wherein the file encryption key is written to the file encryption key database upon uploading.

6. A data archiving system according to claim 5, wherein an identifier (413) is written to a header (410) of the file and to the file encryption key database upon uploading to associate the file encryption key with the encrypted file.

7. A data archiving method comprising:
generating a file encryption key;
encrypting a file with the file encryption key; and, uploading the encrypted file to an archival device;
regenerating the file encryption key upon download of the encrypted file; and, decrypting the file with the regenerated file encryption key.

8. A method according to claim 7, wherein the step of generating the file encryption key comprises generating the file encryption key in dependence on a randomly generated number and a private encryption key and storing the randomly generated number in a header to the file, wherein the step of regenerating the file encryption key comprises the step of obtaining the randomly generated number from the header to the file and regenerating the file encryption key in dependence on a randomly generated number and the private encryption key.

9. A method according to claim 7, further comprising the step of storing data necessary to regenerate the file encryption key in a file encryption key database.

10. A method according to claim 9, further comprising the step of writing data to the file encryption key database for matching the encrypted file to the stored data necessary to regenerate the file encryption key.

11. A method according to claim 10, further comprising the steps of writing an identifier to a header of the file, the identifier comprising the data for matching the encrypted file to the stored data.

12. A computer program comprising computer program code means for performing all of the steps of any of claims 7 to 11 when said program is run on a computer.

13. A computer program as claimed in claim 12 embodied on a computer readable medium.
